(19) United States
(12) Patent Application Publication
(10) Pub. No.: US 2023/0269428 A1
(43) Pub. Date: Aug. 24, 2023

(54) RECOGNIZING A USER OF A DEVICE AND CONFIGURING THE DEVICE IN RESPONSE

(71) Applicant: Avaya Management L.P., Durham, NC (US)

(72) Inventors: Pragati Dhumal, Pune (IN); Tanvi Sharma, Pune (IN)

(21) Appl. No.: 17/678,923

(22) Filed: Feb. 23, 2022

(51) Int. Cl. H04N 21/458; G06V 40/10; G10L 17/06; G10L 25/78; G10L 17/02; H04N 21/422; H04N 21/45; H04N 21/475; H04N 21/441; H04N 21/4223; H04N 21/81

(52) U.S. Cl. CPC H04N 21/458; G06V 40/10; G10L 17/02; G10L 17/06; G10L 25/78; H04N 21/441; H04N 21/812; H04N 21/4223; H04N 21/4532; H04N 21/4755; H04N 21/42203

(57) ABSTRACT

Systems and methods are described to determine a current user of a media presentation device, the current user being determined independently from an account holder associated with a profile on the device or a service utilized by the device. By detecting speech cues a current user’s speech may be compared with a record and, if a match is obtained, a corresponding set of preferences accessed and utilized to configure the media presentation device. Preferences may include exclusions, such as when a user is a minor and inappropriate content is excluded. As a benefit, the media device itself may be configured or media content, such as programs or advertisements, or may be selected and presented by the media device to a current user rather than merely defaulting to the account holder’s profile.

### FIELD OF THE DISCLOSURE

The invention relates generally to systems and methods for detecting an actual user of a device and particularly to configuring a media device in accordance with actual user(s) thereof.

### BACKGROUND

Devices and user accounts, such as on content provider services (e.g., social media, streaming services, etc.) often suggest content to the user based on the user’s prior usage history. Data mining, artificial intelligence, and other services similarly seek to identify content that may be of interest to the user irrespective of the user’s history. These choices and preferences are mapped to the user, commonly via association with the login credentials utilized to access the device and/or content providers’ services. Mapping information is often shared between content providers, such as when the user watches videos on a streaming service and is then presented with relevant advertisements on a social media platform.

However, the device or service is not always utilized by the account holder. For example the device may be a television accessing media content from one or more media providers, but utilized by other members of the household. Content for the account holder may be inappropriate, and therefore should not be provided or suggested to other members of the household, such as minor children. As another example, household members may simply have different tastes from one another and, upon receiving a suggestion intended for one household member, the others are left to discover content on their own accord that suites their own interests. The rationale utilized to suggest content for the account holder is then skewed with content of interests for other family members.

### SUMMARY

In one scenario, John is utilizing his phone and logged into his video streaming account, such as YouTube™. The content suggestions for John on his YouTube™ account are, in whole or nearly so, based on his usage history, subscriptions, likes, etc. When logged into the same video streaming account on a common device, such as a television, the suggestions for content will be based on John’s preferences alone, even if other users, such as John’s children, are the actual viewers of the content and content suggestions. This may result in inappropriate content being suggested to John’s kids.

In another scenario, John has a non-common video streaming account he uses for household devices, such as the family’s television. The preferences of John are different from the preferences of his wife, Julia. But whenever Julia is using the family’s television, the content suggested to her is not content based on her own interests. Similarly, the advertainments presented to Julia are also not relevant because they are based on John’s preferences, or those associated with his account. As a result, backend systems utilizing bandwidth, storage, and computing resources select and present content that is uninteresting or unwanted, and thereby waste resources.

These and other needs are addressed by the various embodiments and configurations of the present invention. The present invention can provide a number of advantages depending on the particular configuration. These and other advantages will be apparent from the disclosure of the invention(s) contained herein.

Systems and methods disclosed herein utilize voice recognition to refine or override the account settings and to determine the identity of the current user in order to provide content that is relevant to them. The current user may be determined as being the actual account holder, and the preferences associated with the account may then be utilized to select content. Alternatively, the current user may be different from the account holder, and the preferences associated with the current user are then selected, if known, or determined, if unknown. As a result, preferences may be mapped to a current user, as determined by their speech, and presented with content relevant to their own interests.

Many devices incorporate built-in microphones with voice detection, such as to receive voice commands. In one embodiment, the voice detection functionality of a device or devices is utilized to detect and learn users’ voices and to map these voices to the users’ preferences that are utilized by the device itself (e.g., volume or brightness setting of a television, favorite/default channel or streaming application, etc.), or a service utilized by the device (e.g., streaming service providing programs, advertisements, etc.). The determined current user and their associated preferences may override, in whole or in part, the preferences of the account holder. Preferences can be updated at regular intervals upon the occurrence of an event (e.g., declining a recommendation, selecting content outside of the expected content, etc.) in order to provide more dynamic content suggestions and relevant advertisements. In another embodiment, the device(s)/service application(s) determine the number of people in the current surroundings, such as the number of people in the same room that are close enough to view content on the same television, and attributes of those individuals (e.g., adult, minor, known user, unknown user encountered previously, unknown user not previously encountered, etc.). In response, the device(s)/service application(s) can select appropriate content for all users or filter out content suggestions/advertisements which are inappropriate to for this particular audience. The solution may be implemented at the device level or at the application level, such as an application utilized to access a service.

In one embodiment, a system is disclosed, comprising: a media presentation device, comprising: an output to present one or more of audio content or video content from a media content; a network connection to a network to receive the media content; a microphone; a data storage; a processor to perform: receiving sound via the microphone; upon determining the sound comprises speech from a first user of the media presentation device, determining a set of speech attributes; comparing the set of speech attributes to a first set of speech attributes in a first record maintained in the data storage to determine whether the speech matches the first data record, the first data record further identifying a first user; and upon determining the speech matches the first data record, configuring the media presentation device to present media content selected in accordance with first set of preferences corresponding to the first data record.

In another embodiment, a method for configuring a media presentation device, comprising: receiving sound from a microphone; upon determining the sound comprises speech from a first user of the media presentation device, determining a set of speech attributes; comparing the set of speech attributes to a first set of speech attributes in a first record maintained in a data storage to determine whether the speech matches the first data record, the first data record further identifying a first user; and upon determining the speech matches the first data record, configuring the media presentation device to present media content selected in accordance with first set of preferences corresponding to the first data record.

In another embodiment, a system for configuring a media presentation device comprising: a server comprising a network interface to a network and a processor comprising machine-readable instructions in a non-transitory memory that when read by the processor cause the processor to perform: receiving, via the network, sound captured by a microphone of a media presentation device; upon determining that the sound comprises speech, determining a set of speech attributes; comparing the set of speech attributes to a first set of speech attributes in a first record maintained in a data storage to determine whether the speech matches the first data record, the first data record further identifying a first user; and upon determining the speech matches the first data record, selecting media content in accordance with first set of preferences corresponding to the first data record; and providing, via the network, the media content to the media presentation device.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a data structure in accordance with embodiments of the present disclosure;

FIG. 3 depicts a data structure in accordance with embodiments of the present disclosure;

FIG. 4 depicts a process in accordance with embodiments of the present disclosure;

FIG. 5 depicts a process in accordance with embodiments of the present disclosure; and

FIG. 6 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

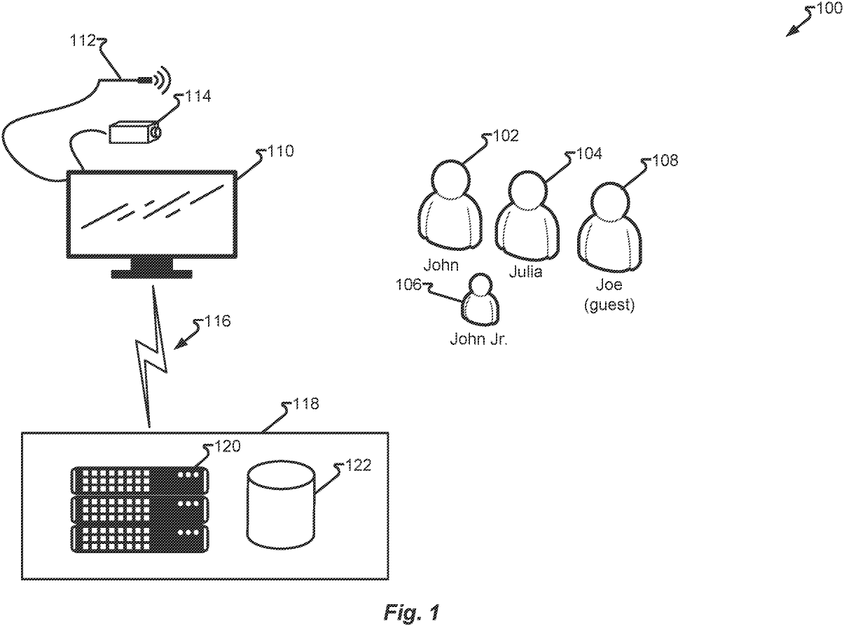

FIG. 1 depicts system 100 in accordance with embodiments of the present disclosure. In one embodiment, media presentation device 110 comprises a media reception component, such as communications link 116 to media provider 118. Additionally or alternatively, media presentation device 110 may receive media, in whole or in part, from a local media server, over-the-air, cable, satellite, etc. wherein the media presented by media presentation device 110 may comprise visual content only (e.g., text, graphics, images, video, etc.), audio content only (e.g., speech, music, etc.), or a combination thereof (e.g., video webcasts, television programs, movies, etc.).

Media presentation device 110 may be configured based on preferences. Preferences may determine how the device itself is configured (e.g., brightness, contrast, closed-captioning on/off, etc.) and how content sources are configured (e.g., showing, hiding, and/or placement of icons associated with media content providers) or configuring the media presented by media presentation device 110 by selecting, not selecting, and/or sequencing of media content. The media content may be explicitly selected or excluded as matching one or more media attributes (e.g., shows with a particular actor, genre of movie, general sports, specific team(s), etc.). Additionally or alternatively, the media may be selected by another party, such as media provider 118 to present advertisements. Media provider 118, and the advertisers who provide ads on the service, may provide general advertisements, such that no particular demographic or interest preference is considered. This may be the case with advertisers for products that have universal, or nearly so, applicability (e.g., food, water, etc.). However, other advertisers may be more particular and not wish to target, pay for, or present advertisements to persons that are known to not be, nor likely to become, customers. For example, an advertiser of products targeting young families (e.g., family-friendly vacations or vehicles, educational products, etc.) would avoid providing such advertisements to demographics that are uninterested in such products or only interested in different products (e.g., vacations at casinos, impractical vehicles, etc.). Accordingly, media provider 118 may select, not select, or sequence media content determined to match a preference or other attribute (e.g., demographic) known or reasonably suspected to be of interest to a particular user of media presentation device 110.

While most media presentation devices, such as media presentation device 110, and media providers, such as media provider 118, require or enable the establishment of a user account for the device or services utilized, often the account holder is only one of a number of users of media presentation device 110.

In one embodiment, user 102 (“John”) is the account holder for a user profile on media presentation device 110 and/or media provider 118. However, user 102 is not the only person who utilizes media presentation device 110. For example, user 104 (“Julia”) and user 106 (“John Jr.”) are members of the household and routinely utilize media presentation device 110. Additionally or alternatively, user 108 (“Joe”) may be a guest (e.g., a visiting family member) who may utilize media presentation device 110 whether alone or with other members of the household (e.g., user 102, user 104, and/or user 106). However, user 108 may merely be a transient guest (e.g., delivery or repair personnel) while media presentation device 110 is being utilized by a member of the household or merely left on with no member of the household presently utilizing media presentation device 110.

In one embodiment, media presentation device 110 operates in a configured mode, such as when a known user is presently engaged with media presentation device 110, having one or more preferences for the user also known. Engagement with media presentation device 110 may be determined by being proximate to media presentation device 110, being seen by camera 114, being heard by microphone 112, operating an input of media presentation device 110 or associated therewith (e.g., remote), and/or by other means wherein engagement can be known or reasonably assumed. Assumptions may include hearing cooking noises from another room (thereby concluding a user as being the source of such noises), wherein a user, whether known or unknown, cannot be seen by camera 114, but the audio output of media presentation device 110 is at a sufficient volume that allows the user in the other room to hear the output and, therefore, be determined to be engaged with media presentation device 110.

As will be described more completely with respect to embodiments that follow, a user is known, in one embodiment, when a specific human being is identified, such as when a human entity is known (conclusively or optionally with an above threshold confidence) by name, account username, account number, etc. In another embodiment, a user is known if a particular user has attributes, such as speech attributes, that match such attributes in an existing record (e.g., the user with the same speech patterns as those of the user that was engaged with media presentation device 110 an hour ago, yesterday, etc.). In another embodiment, a user is known when they are a member of a finite set of users wherein all but one can be excluded as a user of media presentation device 110 at a particular time. Additionally or alternatively, whether a user is known may be determined when attributes of a current user sufficiently match those of a previously existing record. For example, a user’s speech attributes will normally vary, such as if they are alert, tired, distracted, attentive, in a good mood/bad mood, etc. If the differences between the current speech attribute(s) and the previously obtained speech attribute(s) are limited to such normal variations, then a match may be determined.

As a benefit of the embodiments herein, a current user, or users, of media presentation device 110 may be determined, in whole or in part, independently from any registered user of media presentation device 110 and/or media provider 118 that may already be known. By utilizing a sensor (e.g., camera 114, microphone 112, etc.), an actual current user (e.g., watcher and/or listener) may be compared to records of known users, such as maintained in data storage 122, whether known conclusively or, in another embodiment, known as a previously encountered user. With the actual user(s) known, preferences may be accessed and utilized to select and present desired or matching media content, such as by server 120, and/or to exclude or de-select undesired or inappropriate media content.

Media presentation device 110 may comprise a network interface to a network and/or a network interface to a peripheral device that, in turn, accesses and connects media presentation device 110 to a network (e.g., internet). Media presentation device 110 may comprise one or more processors, a data storage, memory, etc., and/or access such components as peripheral and/or networked components accessible to media presentation device 110.

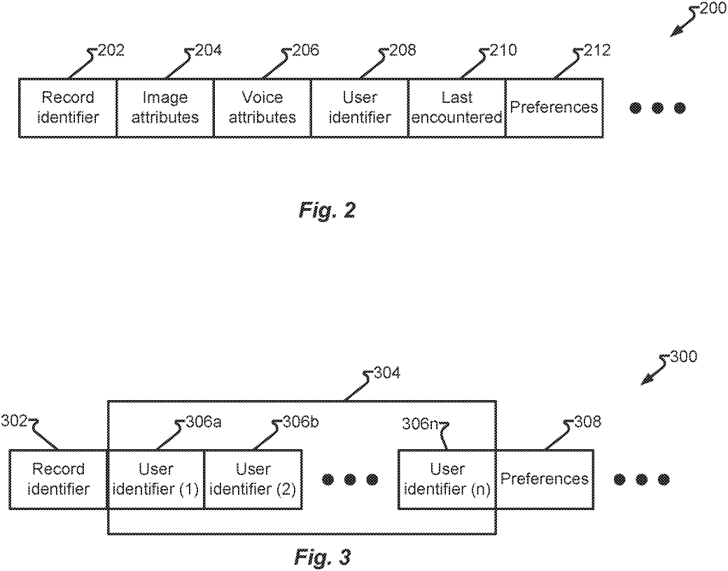

FIG. 2 depicts data structure 200 in accordance with embodiments of the present disclosure. In one embodiment, data structure 200 defines a number of records maintained in a data storage, such as data storage 122. It should be appreciated that data storage 122 may be located elsewhere without departing from the scope of the disclosure, such as when embodied as a component of media presentation device 110 or a third-party service external to media provider 118 and media presentation device 110 but accessible thereto via communications link 116.

In one embodiment, data structure 200 comprises a number of fields, such as data record 202, which may provide an index, key, or other reference to identify a particular record. Image attributes 204 is optionally included and utilized to maintain visual and/or descriptive indicia (e.g., facial features, body shape, etc.) of persons captured by camera 114. For example, one or more images may be maintained and a comparison is made to a live image to determine if a match is present and, if so, the person identified in user identifier 208 is determined to be utilizing media presentation device 110. Similarly, voice attributes 206 maintains speech or similar vocalized samples and/or descriptions of the voiceprint (e.g., frequency, flutter, pace, etc.) of a particular individual. If a comparison is made to a live sound that matches, such as voice attribute 206, then the corresponding person identified in the record in user identifier field 208 is determined to be utilizing media presentation device 110.

Optionally, last encountered 210 maintains the time/date of when the person identified in user identifier 208 was seen, heard, or otherwise determined to be present and, therefore, utilizing media presentation device 110. Last encountered 210 may be a single datum or a data structure maintaining a series of times and dates last encountered and optionally the duration of such encounters. As a benefit, transient users, such as when user 108 is a delivery person, may be determined to be present for a limited time and with a relatively small number of encounters, typically one or two. As a result, the record of user 108 may be determined as being a user that was only transient and, therefore, may be removed to avoid further consideration by a processor executing instructions to identify users.

Preferences 212 may comprise a single record or data structure to maintain likes, dislikes, setting preferences, or other attributes indicating media content that is or is not appropriate. For example, a record for user 106 (a minor child) may include a preference or other indication of age such that media content only suitable for adults is excluded when user 106 is identified as being present.

FIG. 3 depicts data structure 300 in accordance with embodiments of the present disclosure. While media presentation device 110 may be utilized by a single user, such devices may also be utilized by a plurality of users. When such group usage is implemented, the preferences may be different from those of the users individually. For example, user 102 (John) when utilizing media presentation device 110 alone may have a strong preference for sports, while user 104 (Julia) when utilizing media presentation device 110 by herself alone may have a strong preference for dramas. However, when both user 102 and user 104 are concurrently utilizing media presentation device 110 their aggregate preference may be for comedies. Additional or alternative settings may be utilized. In other embodiments, the preferences may be interspersed, such that each of user 102 and user 104 preferences are utilized and then the other as a back-and-forth or “round robin” selection between two or more users. For example, by utilizing each user’s preferences, media presentation device 110 may present a short sports update, followed by a twenty-minute drama, followed by a fifteen-minute sports highlights program, etc. Additionally or alternatively, preferences may indicate content to always include or exclude if available. For example, user 102 detests a particular actor popular in current dramas and, as a result, selecting a drama in accordance with the preferences of user 104 would then exclude that particular actor as well. Similarly, user 104 may hate auto racing and, as a result, sports programming selected in accordance with the preferences of user 102 is then filtered to remove auto racing as well. Similarly, a user, such as user 106, may be a minor and any programming selected in accordance with any other rule is filtered to remove media content inappropriate for minors as well.

Accordingly, in one embodiment, data structure 300 defines a number of records maintained in a data storage, such as data storage 122. It should be appreciated that data storage 122 may be located elsewhere without departing from the scope of the disclosure, such as when embodied as a component of media presentation device 110 or a third-party service external to media provider 118 and media presentation device 110 but accessible thereto via communications link 116. Record identifier 302 comprises an index, key, or other identifier of a specific record. User block 304 identifies the users that are to be concurrently utilizing media presentation device 110 and the corresponding preferences 308.

Block 304 comprises two or more identifiers for individual users, such as user identifier 1 (306a), user identifier 2 (306b) and may include more user identifiers n (306n). Preferences 308 then determines the settings, content to include, any content to exclude, etc. when utilizing media presentation device 110. For example, when John and Julia only are the users of media presentation device 110, user block 304 for user 102 and user 104 (and no other) are maintained in one record and the corresponding preferences 308 are utilized to configure media presentation device 110. When John Jr. (user 106) is present, then the record identifying each of user 102, user 104, and user 106 is utilized and that record’s corresponding preferences are utilized to configure media presentation device 110.

It should be appreciated that any inputs received by media presentation device 110 that affect a preference may cause preferences 308 and/or preferences 212 (see FIG. 2) to be updated, added, or deleted to reflect the current preferences of the one or more users.

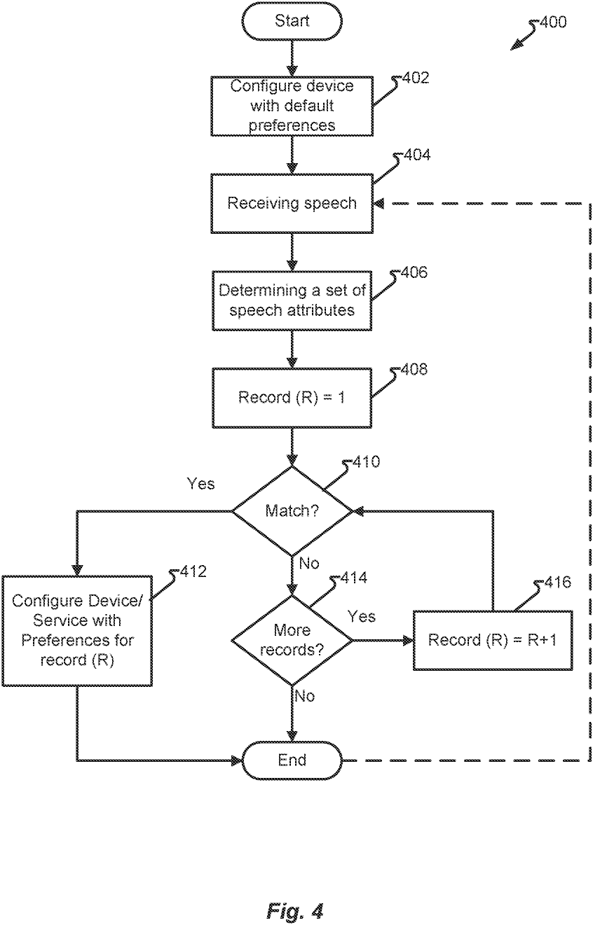

FIG. 4 depicts process 400 in accordance with embodiments of the present disclosure. In one embodiment, process 400 is embodied as machine-readable instructions maintained in a non-transitory data storage that, when read by a processor, cause the processor to perform the steps of process 400. In one embodiment, process 400 begins and (optionally) media presentation device 110 is configured with default components in step 402, such as when no user or no known user is identified as utilizing media presentation device 110. Step 404 receives speech. Speech may be suitably filtered to exclude any sound/speech originating from media presentation device 110 and thereby only capturing speech spoken by users of media presentation device 110. Step 506 then determines a set of attributes for the speech and, in step 408, accesses a first record compromising speech attributes, such as records maintained in microphone 112 utilizing data structure 300 and/or data structure 400.

Test 410 then determines if the speech attributes of the speech obtained in step 404 match the speech attributes in the current record. If test 410 is determined in the affirmative, step 412 then configures media presentation device 110 in accordance with corresponding preferences within the record. If test 410 is determined in the negative, then test 414 determines if more records are present. Test 410 may be a match when a non-exact match occurs. For example, if a match is determined to have an acceptable margin of error or match within a threshold variation, then test 410 is determined in the affirmative. If test 414 is determined in the affirmative, then step 416 accesses the next record and loops back to test 410. If test 414 is determined in the negative, then process 400 ends. Optionally, process 400 may loop back to step 404 and repeat indefinitely, or at least while media presentation device 110 is powered, utilized by someone, etc.

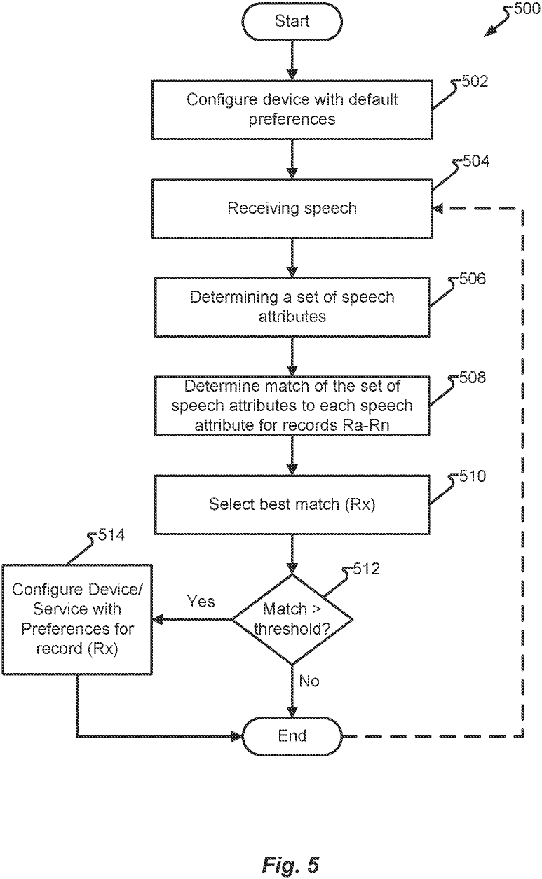

FIG. 5 depicts process 500 in accordance with embodiments of the present disclosure. In one embodiment, process 500 is embodied as machine-readable instructions maintained in a non-transitory data storage that, when read by a processor, cause the processor to perform the steps of process 500. In one embodiment, process 500 begins with (optionally) step 502 configuring media presentation device 110 with a set of default preferences. Step 504 then receives speech similar to step 404 (see FIG. 4) and, in step 506, determines a set of speech attributes, similar to step 406 (Id.).

Step 508 the determines a best match of the speech attributes of the speech obtained in step 504 to the speech attributes in a set of records (“records Ra-Rn”). Step 510 then selects the best match, such as the record having the speech attributes that have the least amount of variation from the speech attributes obtained from the speech in step 504. Test 512 determines if the match is greater than a threshold amount and, if determined in the affirmative, step 514 selects the corresponding preferences and configures media presentation device 110 therewith. If step 514 is determined in the negative, process 500 may end, such as to allow media presentation device 110 to operate with default preferences, or optionally loop back to step 504 to operate indefinitely, or at least while media presentation device 110 is operating.

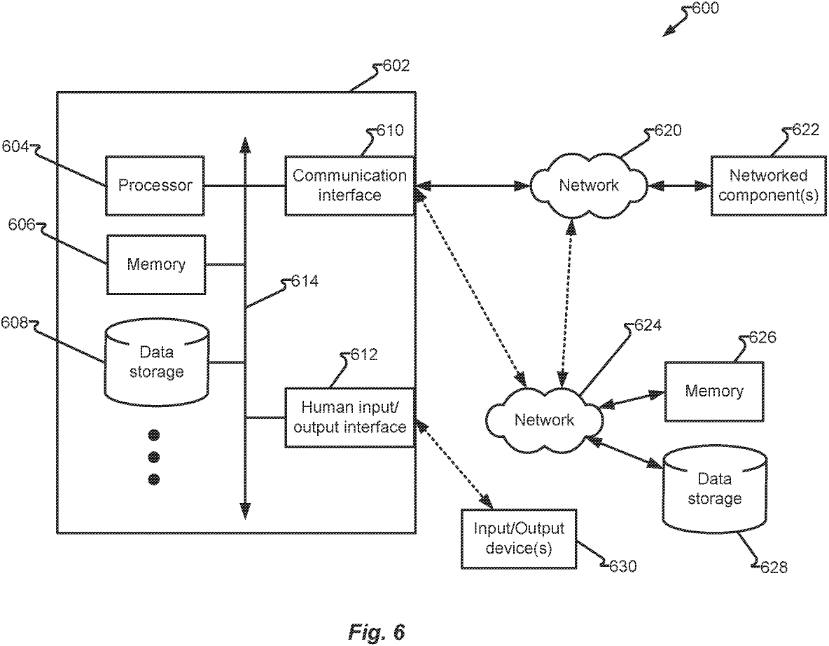

FIG. 6 depicts device 602 in system 600 in accordance with embodiments of the present disclosure. In one embodiment, media presentation device 110 and/or media provider 118 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may comprise a programmable logic functionality, such as logic determined, at least in part, from accessing machine-readable instructions maintained in a non-transitory data storage, which may be embodied as circuitry, on-chip read-only memory, memory 606, data storage 608, etc., that cause the processor 604 to perform the steps of the instructions. Processor 604 may be further embodied as a single electronic microprocessor or multiprocessor device (e.g., multicore) having electrical circuitry therein, which may further comprise a control unit(s), input/output unit(s), arithmetic logic unit(s), register(s), primary memory, and/or other components that access information (e.g., data, instructions, etc.), such as received via bus 614, execute instructions, and output data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to enable VAX-specific applications to execute on a virtual VAX processor), however, as those of ordinary skill understand, such virtual processors are applications executed by hardware, or more specifically, the underlying electrical circuitry and other hardware of the processor (e.g., processor 604). Processor 604 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize memory 606 and/or data storage 608 for the storage of accessible data, such as instructions, values, etc. Communication interface 610 facilitates communication with other components, such as processor 604 via bus 614, with components not accessible via bus 614. Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or an electronic device. Examples of input/output device 630 that may be connected to human input/output interface 612 include, but are not limited to, a keyboard, a mouse, a trackball, a printer, a display, a sensor, a switch, a relay, a speaker, a microphone, a still and/or video camera, etc. In another embodiment, communication interface 610 may comprise, or be comprised by, human input/output interface 612. Communication interface 610 may be configured to communicate directly with a networked component or utilize one or more networks, such as network 620 and/or network 624.

Communications link 116 may be embodied, in whole or in part, as network 620. Network 620 may be a wired network (e.g., Ethernet), a wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.).

Additionally or alternatively, one or more other networks may be utilized. For example, network 624 may represent a second network, which may facilitate communication with components utilized by device 602. For example, network 624 may be an internal network of a business entity or other organization, whereby components are trusted (or at least more so) that networked components 622, which may be connected to network 620 comprising a public network (e.g., Internet) that may not be as trusted.

Components attached to network 624 may include memory 626, data storage 628, input/output device(s) 630, and/or other components that may be accessible to processor 604. For example, memory 626 and/or data storage 628 may supplement or supplant memory 606 and/or data storage 608 entirely or for a particular task or purpose. For example, memory 626 and/or data storage 628 may be an external data repository (e.g., server farm, array, “cloud,” etc.) and enable device 602, and/or other devices, to access data thereon. Similarly, input/output device(s) 630 may be accessed by processor 604 via human input/output interface 612 and/or via communication interface 610 either directly via network 624, alone via network 620 (not shown), or via a combination of networks 624 and 620. Each of memory 606, data storage 608, memory 626, data storage 628 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 630 may be a router, switch, port, or other communication component such that a particular output of processor 604 enables (or disables) input/output device 630, which may be associated with network 620 and/or network 624, to allow (or disallow) communications between two or more nodes on network 620 and/or network 624. One of ordinary skill in the art will appreciate that other communication equipment may be utilized in addition to or as an alternative to those described herein without departing from the scope of the embodiments.

In the foregoing description, for the purposes of illustration, methods were described in a particular order. It should be appreciated that, in alternate embodiments, the methods may be performed in a different order than that described herein without departing from the scope of the embodiments. It should also be appreciated that the methods described above may be performed as algorithms executed by hardware components (e.g., circuitry) purposely built to carry out one or more algorithms, or portions thereof, described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely, or in part, in a discrete component connected via a communications link 116 (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor, whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform’s native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A media presentation device, comprising:
an output to present one or more of audio content or video content from a media content;
a network connection to a network to receive the media content;
a microphone;
a data storage;
a processor to perform:
receiving sound via the microphone;
upon determining the sound comprises speech from a first user of the media presentation device, determining a set of speech attributes;
comparing the set of speech attributes to a first set of speech attributes in a first record maintained in the data storage to determine whether the speech matches the first data record, the first data record further identifying a first user; and
upon determining the speech matches the first data record, configuring the media presentation device to present media content selected in accordance with first set of preferences corresponding to the first data record.

2. The media presentation device of claim 1, wherein:
the data storage further maintains a second record, the second record comprising a second set of attributes;
comparing the set of speech attributes to each of the first set of speech attributes in the first record and to the second set of speech attributes of the second record to determine a best match to the set of speech attributes;
upon determining the best match comprises the first set of attributes, configuring the media presentation device to present media content selected in accordance with the first set of preferences; and
upon determining the best match comprises the second set of attributes, configuring the media presentation device to present media content selected in accordance with a second set of preferences corresponding to the second data record.

3. The media presentation device of claim 1, wherein:
the data storage further maintains a second record, the second record comprising a second set of attributes;
the processor further performs comparing the set of speech attributes to each of the first set of speech attributes in the first record and to the second set of speech attributes of the second record to determine a best match to the set of speech attributes;
the processor further performs, upon determining that portions of the set of speech attributes, received during a previously determined period of time associated with concurrent usage of the media presentation device, match each of the first set of speech attributes and the second set of speech attributes; and
the processor further performs, configuring the media presentation device to present media content selected in accordance with both the first set of preferences and a second set of preferences corresponding to the second data record.

4. The media presentation device of claim 1, wherein configuring the media presentation device to present media content selected in accordance with both the first set of preferences and the second set of preferences corresponding to the second data record, further comprises at least one of: (i) selecting media content selected in accordance with the first set of preferences interspersed with selecting media content selected in accordance with the second set of preferences, (ii) selecting media content selected in accordance with a common record associated with utilization of the media presentation device currently by a plurality of users associated with the first set of preferences and the second set of preferences, (iii) configuring the media presentation device to present media content in accordance with at least one the first set of preferences or the second set of preferences but excluding any media content associated with no interest for at least one of the first set of preferences or the second set of preferences, or (iv) configuring the media presentation device to present media content in accordance with at least one the first set of preferences or the second set of preferences but excluding any media content determined to be inappropriate for each of the first user or a second user associated with the second set of preferences.

5. The media presentation device of claim 1, wherein
the data storage maintains a plurality of records that include the first record, each of the plurality of records comprising a set of speech attributes;
the processor further performs comparing the set of speech attributes to the set of speech attributes for each of plurality of records determine a best match to the set of speech attributes;
the processor performs, upon determining that none of the set of speech attributes for any of the plurality of records matches, within a previously determined threshold, the speech attributes, creating a new record comprising the set of speech attributes; and
the processor performs causing the data storage to maintain the new record as one of the plurality of records.

6. The media presentation device of claim 5, wherein the processor causes the data storage to maintain the new record to comprise a corresponding set of preferences set to comprise a previously determined default set of preferences.

7. The media presentation device of claim 1, further comprising:
a user input component to receive indicia of content of interest;
wherein the processor further performs at least one of: (i) upon receiving indicia of content of interest, causing the data storage to add the indicia of the content of interest and at least one attribute of the content of interest to the first set of preferences or (ii) upon receiving indicia of content of no interest, causing the data storage to perform at least one of:
adding the indicia of no interest and at least one attribute of the content of no interest to the first set of preferences; and
removing from the first set of preferences indicia of interest associated with the at least one attribute of the content of interest previously added to the first set of preferences.

8. The media presentation device of claim 1, further comprising:
a camera; and
wherein the processor performs at least one of identifying the first user via image recognition from an image captured by the camera and associated with the first data record or identifying an unknown user that is known to not be the first user via image recognition from the image captured by the camera and not associated with the first data record.

9. The media presentation device of claim 8, further comprising the processor creating a new data record to be maintained in the data storage, the new data record comprising visual indicia of the unknown user and, while the user is utilizing the media presentation device, determining at least one attribute of media content preferences to be maintained with the new data record.

10. A method for configuring a media presentation device, comprising:
receiving sound from a microphone;
upon determining the sound comprises speech from a first user of the media presentation device, determining a set of speech attributes;
comparing the set of speech attributes to a first set of speech attributes in a first record maintained in a data storage to determine whether the speech matches the first data record, the first data record further identifying a first user; and
upon determining the speech matches the first data record, configuring the media presentation device to present media content selected in accordance with first set of preferences corresponding to the first data record.

11. The method of claim 10, wherein:
the data storage further maintains a second record, the second record comprising a second set of attributes;
comparing the set of speech attributes to each of the first set of speech attributes in the first record and to the second set of speech attributes of the second record to determine a best match to the set of speech attributes;
upon determining the best match comprises the first set of attributes, configuring the media presentation device to present media content selected in accordance with the first set of preferences; and
upon determining the best match comprises the second set of attributes, configuring the media presentation device to present media content selected in accordance with a second set of preferences corresponding to the second data record.

12. The method of claim 10, wherein:
maintaining, in the data storage, a second record, the second record comprising a second set of attributes;
comparing further comprising comparing the set of speech attributes to each of the first set of speech attributes in the first record and to the second set of speech attributes of the second record to determine a best match to the set of speech attributes;
upon determining that portions of the set of speech attributes, received during a previously determined period of time associated with concurrent usage of the media presentation device, match each of the first set of speech attributes and the second set of speech attributes; and
configuring the media presentation device further comprising configuring the media presentation device to present media content selected in accordance with both the first set of preferences and a second set of preferences corresponding to the second data record.

13. The method of claim 10, wherein configuring the media presentation device to present media content selected in accordance with both the first set of preferences and the second set of preferences corresponding to the second data record, further comprises at least one of: (i) selecting media content selected in accordance with the first set of preferences interspersed with selecting media content selected in accordance with the second set of preferences, (ii) selecting media content selected in accordance with a common record associated with utilization of the media presentation device currently by a plurality of users associated with the first set of preferences and the second set of preferences, (iii) configuring the media presentation device to present media content in accordance with at least one the first set of preferences or the second set of preferences but excluding any media content associated with no interest for at least one of the first set of preferences or the second set of preferences, or (iv) configuring the media presentation device to present media content in accordance with at least one the first set of preferences or the second set of preferences but excluding any media content determined to be inappropriate for each of the first user or a second user associated with the second set of preferences.

14. The method of claim 10, wherein
maintaining, in the data storage, a plurality of records that include the first record, each of the plurality of records comprising a set of speech attributes;
comparing the set of speech attributes to the set of speech attributes for each of plurality of records determine a best match to the set of speech attributes;
upon determining that none of the set of speech attributes for any of the plurality of records matches, within a previously determined threshold, the speech attributes, creating a new record comprising the set of speech attributes; and
causing the data storage to maintain the new record as one of the plurality of records.

15. The method of claim 14, further comprising causing the data storage to maintain the new record to comprise a corresponding set of preferences set to comprise a previously determined default set of preferences.

16. The method of claim 10, further comprising:
a user input component receiving an indicia of content of interest;
performing at least one of: (i) upon receiving the indicia of content of interest, causing the data storage to add the indicia of the content of interest and at least one attribute of the content of interest to the first set of preferences or (ii) upon receiving indicia of content of no interest, causing the data storage to perform at least one of:
adding the indicia of no interest and at least one attribute of the content of no interest to the first set of preferences; and
removing from the first set of preferences indicia of interest associated with the at least one attribute of the content of interest previously added to the first set of preferences.

17. The method of claim 10, wherein:
the media presentation device comprises a camera; and
performing at least one of identifying the first user via image recognition from an image captured by the camera and associated with the first data record or identifying an unknown user that is known to not be the first user via image recognition from the image captured by the camera and not associated with the first data record.

18. The method of claim 17, further comprising creating a new data record to be maintained in the data storage, the new data record comprising visual indicia of the unknown user and, while the user is utilizing the media presentation device, determining at least one attribute of media content preferences to be maintained with the new data record.

19. A system for configuring a media presentation device comprising:
a server comprising a network interface to a network and a processor comprising machine-readable instructions in a non-transitory memory that when read by the processor cause the processor to perform:
receiving, via the network, sound captured by a microphone of a media presentation device;
upon determining that the sound comprises speech, determining a set of speech attributes;
comparing the set of speech attributes to a first set of speech attributes in a first record maintained in a data storage to determine whether the speech matches the first data record, the first data record further identifying a first user; and
upon determining the speech matches the first data record, selecting media content in accordance with first set of preferences corresponding to the first data record; and
providing, via the network, the media content to the media presentation device.

20. The system of claim 20, wherein the media content comprises at least one of a media content program or an advertisement.
